(19) United States
(12) Patent Application Publication
(10) Pub. No.: US 2023/0291473 A1
(43) Pub. Date: Sep. 14, 2023

(54) PARALLEL RECEIVER MODULE

(71) Applicant: KABUSHIKI KAISHA TOSHIBA, Tokyo (JP)

(72) Inventor: Hideto FURUYAMA, Yokohama (JP)

(73) Assignee: KABUSHIKI KAISHA TOSHIBA, Tokyo (JP)

(21) Appl. No.: 17/821,299

(22) Filed: Aug. 22, 2022

(30) Foreign Application Priority Data
Mar. 10, 2022 (JP) 2022-036872

(51) Int. Cl. H04B 10/2507; H04B 10/079; H04Q 11/00; H04B 10/60

(52) U.S. Cl. CPC H04B 10/2507; H04B 10/0799; H04Q 11/0003; H04B 10/60

(57) ABSTRACT

A parallel receiver module includes a plurality of signal transmission lines arranged in a first direction; and a receiving semiconductor chip including a plurality of receiving channels arranged in the first direction. The plurality of receiving channels includes receiving circuits configured to receive signals from the signal transmission lines. At least one receiving channel among the plurality of receiving channels further includes a monitor circuit monitoring a receiving level of the signal from the signal transmission line. The at least one receiving channel is connectable with the signal transmission line by switching between the receiving circuit and the monitor circuit.

### CROSS-REFERENCE TO RELATED APPLICATION

This application is based upon and claims the benefit of priority from Japanese Patent Application No. 2022-036872, filed on Mar. 10, 2022; the entire contents of which are incorporated herein by reference.

### FIELD

Embodiments described herein relate to a parallel receiver module.

### BACKGROUND

A parallel receiver module includes multiple receiving channels, and it is necessary to set appropriate receiving levels according to the strength of the transmission signals. In a parallel receiver module such as, for example, a parallel optical receiver module, optical axis alignment is necessary between an optical fiber array and a photo detector array that receives the optical signals from the optical fiber array.

### BRIEF DESCRIPTION OF THE DRAWINGS

FIG. 1 is a schematic configuration diagram showing the configuration of a parallel receiver module of a first embodiment;

FIG. 2 is a schematic configuration diagram showing the configuration of a parallel receiver module of a second embodiment;

FIG. 3 is a schematic configuration diagram showing the configuration of a parallel receiver module of a third embodiment;

FIG. 4 is a timing chart showing an operation of a parallel receiver module of the embodiment;

FIG. 5 is a block diagram showing a configuration overview of a monitor channel for the embodiment;

FIG. 6 is a circuit diagram showing a configuration example of the parallel receiver module of the embodiment; and

FIG. 7 is a timing chart showing an operation of a parallel receiver module of the embodiment.

### DETAILED DESCRIPTION

According to one embodiment, a parallel receiver module includes a plurality of signal transmission lines arranged in a first direction; and a receiving semiconductor chip including a plurality of receiving channels arranged in the first direction. The plurality of receiving channels includes receiving circuits configured to receive signals from the signal transmission lines. At least one receiving channel among the plurality of receiving channels further includes a monitor circuit monitoring a receiving level of the signal from the signal transmission line. The at least one receiving channel is connectable with the signal transmission line by switching between the receiving circuit and the monitor circuit.

Exemplary embodiments will now be described with reference to the drawings.

The drawings are schematic or conceptual; and the relationships between the thickness and width of portions, the proportional coefficients of sizes among portions, etc., are not necessarily the same as the actual values thereof. Furthermore, the dimensions and proportional coefficients may be illustrated differently among drawings, even for identical portions.

In the specification of the application and the drawings, components similar to those described in regard to a drawing therein above are marked with like reference numerals, and a detailed description is omitted as appropriate.

Major forms of high-speed digital signal transmission include high-speed serial transmission and parallel transmission. High-speed serial transmission is problematic in extremely large transmission bands such as, for example, 100 Gbps or more due to difficulty increasing the speed due to the physical limits of transmission lines and the internal wiring performance of transmission modules, and due to failure caused by performance and power consumption when the transmitting circuit of the transmitter module or the receiving circuit of the receiver module is integrated into a semiconductor chip. On the other hand, parallel transmission requires an enormous number of transmission channels when parallelized using the minimum unit processing speed of an information processing LSI (Large Scale Integration circuit), etc.; and the number of physical transmission lines may cause failure.

Therefore, signal transmissions that require an extremely large bandwidth generally use a hybrid transmission in which higher capacity is realized by using parallelized multiple serial transmission channels in a signal band that does not place an extreme load on the semiconductor chips in which the transmitting circuits and the receiving circuits are integrated.

In such a case, methods include asynchronous transmission of independent transmission channels, or synchronous transmission of the transmission channels. The former is used when the transmission bandwidth of the transmission channel is extremely high and interchannel synchronization cannot be guaranteed, and requires a timing extraction circuit such as a CDR (Clock Data Recovery) circuit, etc., at the receiving side for each transmission channel. This is problematic in that the receiver module has large power consumption and a complex and large configuration. On the other hand, the latter requires a CDR circuit for a specific channel, or a dedicated clock transmission channel used to synchronously receive multiple channels; it is therefore necessary to suppress the channel bandwidth to a speed that can guarantee synchronization of multiple transmission lines.

The former is suitable for long-distance communication, etc., while the latter has a simple configuration and relatively low power consumption and is suitable for transmission within a device or between proximate devices. The former method can called serial array transmission, and has a slightly different concept from parallel transmission. The latter is referred to as “parallel transmission” hereinbelow.

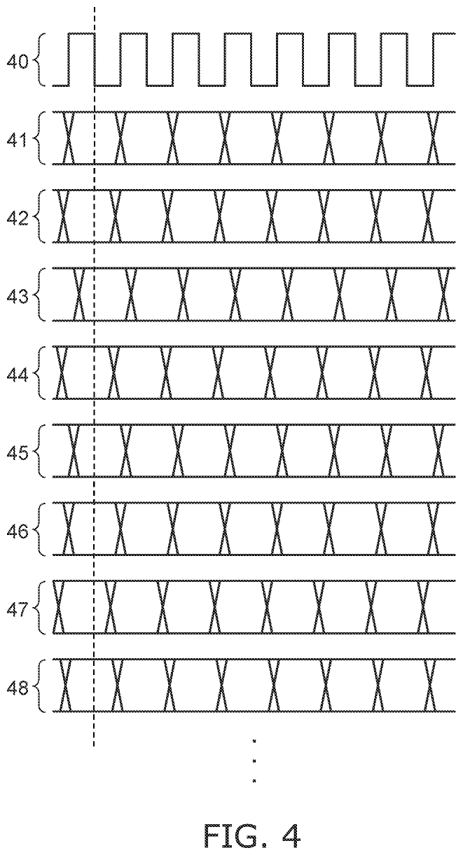

FIG. 4 is a timing chart showing the concept of parallel transmission according to the embodiment, and shows a received waveform (a clock) 40 of the clock receiving channel and received waveforms 41 to 48 of data receiving channels. These received signals are synchronized with the clock 40 to discriminate the signals of the data receiving channels. For example, the data of each receiving channel is discriminated at the timing of the fall of the clock 40 shown by the broken line of FIG. 4.

At this time, it is essential that the signal transition regions of the receiving channels do not overlap the timing of the data discrimination, and the transmission requirements (the transmittable bandwidth or number of synchronizable channels) require that the data phases of all channels for discriminating the data are within this range. Therefore, the phase margin of the transmission channels determine the parallel transmission parameters such as how many transmission channels for subdividing the total transmission bandwidth, how many transmission channel units per synchronous clock, etc.; and the phase margin of the transmission channels is determined by transmission line dispersion characteristics, channel isometry, signal delay dispersion in the transmitting circuit and the receiving circuit, etc. The number of parallel transmission channels per one synchronous clock can be assigned in units of, for example, 2, 4, 8, 16, 32, etc.

For example, for a unit transmission channel bandwidth of 2.5 Gbps, 200 channels and 400 channels of parallel transmission channels would be necessary respectively for the extremely large-capacity signal transmission of, for example, 500 Gbps and 1 Tbps. It is not easy to perform the parallel transmission of so many channels by one transmission module, and generally, multiple unit modules of 8, 16, or 32 parallel channels are used. For example, eight data channels are assigned per synchronous clock channel for a total of nine channels as the unit transmission channel, and, for example, two unit transmission channels ((1 clock+8 data)×2=18 channels) are used as the number of parallel transmission channels of the unit module.

The phase margin of the transmission channels described above is a maximum when the threshold for data discrimination is at the center between the “H” level and the “L” level of the received waveform. Therefore, in a receiving circuit having a fixed threshold, signal level fluctuation due to transmission channel loss, etc., may cause the transmission channel phase margin to be smaller than necessary. Accordingly, it is desirable to optimize the threshold of the data discrimination by detecting the receiving level of the signal in the receiving circuit.

However, it is unnecessary to control the data discrimination threshold in real time; and it is sufficient to control the data discrimination threshold when the transmission channels are changed (e.g., the transmission cables are replaced, etc.) or to control the data discrimination threshold to track relatively mild fluctuations according to the operation temperature change; and it is sufficient to be able to set the receiving level when starting signal transmission and to regularly monitor the receiving level. It is unnecessary to detect the levels of all channels of the parallel transmission; for example, one channel may be monitored per unit transmission channel of parallel transmission using one synchronous clock, or one or two channels may be monitored per parallel receiver module.

When the parallel receiver module is an optical parallel receiver module, a ribbon optical fiber in which one column of multiple optical fibers are arranged at a pitch of, for example, 250 μm must be optically coupled to the optical receiver module. Generally, it is necessary to perform optical axis adjustment to optically couple the optical fibers and the photo detectors of the optical receiver module; optical axis adjustment is nearly unavoidable particularly when the optical fiber is a single-mode fiber.

In the case of an optical transmitter module, the optical axis adjustment can be performed by using an optical power meter, etc., to monitor the average value of the optical transmission output or the optical bias value (the DC component); however, it is not always easy to analogously monitor changes of the optical coupling because there are often cases where signals of optical receiver modules are output via an AGC (Automatic Gain Control) circuit for ensuring the receiver dynamic range, an AOC (Automatic Offset Canceler) circuit for reducing the front-end circuit noise, or the like, or because a bias voltage matching the input logic level of the information device may be output, or the output current may be made constant such as in a LVDS (Low Voltage Differential Signal) interface, etc.

Therefore, a method may be used in which the photo detector output of the optical receiver module is monitored, a ROSA (Receiver Optical Sub Assembly) in which the optical fiber and the photo detector are optically coupled is made, and then the ROSA and the optical receiving circuit are assembled in an integrated optical receiver module.

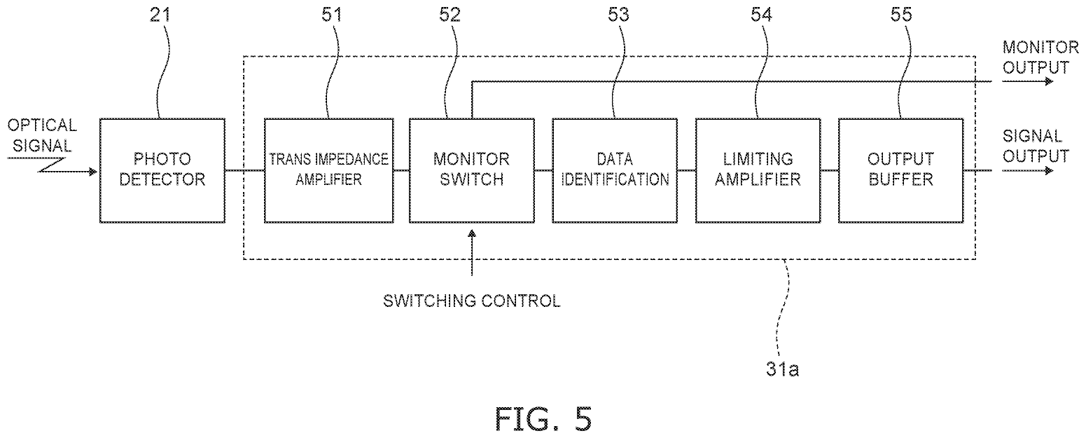

However, in a parallel optical receiver module that uses a large number of channels for parallel transmission as described above, for example, it is necessary to mount ten to twenty unit modules in parallel, and it is necessary to minimize the unit module size to mount the parallel receiver modules at high density. To downsize the optical parallel receiver module, it is desirable for the optical receiving channel to include an optical receiving level monitor to perform the optical axis adjustment without using ROSA. For example, as shown in FIG. 5, the optical receiving level monitor is possible by extracting the output voltage of a TIA (Trans Impedance Amplifier) that performs voltage conversion of the output signal (the photocurrent) of a photo detector (a photoelectric conversion element) 21.

However, to perform optical coupling (the optical axis adjustment) between a ribbon optical fiber and a photo detector array, it is sufficient to be able to monitor the optical receiving levels of two channels among the array elements. For example, two optical receiving level monitors are performed at two end channels of the ribbon optical fiber. This is because the accuracy of the optical axis adjustment can be maximized by monitoring the optical axes at the most distant positions. Because ribbon optical fibers of 2, 4, 8, or 12 channels are the de facto standard, when 18 channels are included as in the unit parallel receiver module described above, for example, two 12-core ribbon optical fibers (24 cores) may be fixed in a 250 μm pitch V-groove array substrate to perform the optical coupling to the photo detector array. Although various cases may be considered when assigning 18 channels among such 24 optical fibers, in any case, it is sufficient to perform the light-receiving level monitor for optical axis adjustment on the two outermost active channels.

Thus, by including receiving level monitors at one or two channels among the unit parallel transmission channels, the optimum receiving level can be set for a parallel receiver module, and the optical axis adjustment can be monitored for fiber optic coupling for an optical parallel receiver module, thereby improving the parallel transmission performance and minimizing the module size.

Although the receiving level monitor can be a continuous monitor, the addition of the monitor circuit easily causes an increase of the signal delay dispersion between the receiving channels due to nonuniformity of the receiving circuit; it is therefore desirable to include a monitor switching circuit 52 that connects the monitor circuit only during the regular receiving level monitor or during the optical axis adjustment. When there are an ample number of transmission channels, for example, the dedicated channel for receiving level monitoring may be included in each set of unit parallel receiving channels or in each unit parallel receiver module.

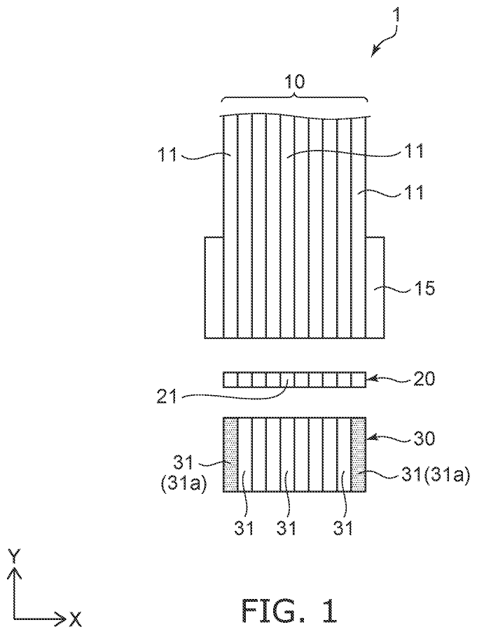

The parallel receiver module 1 shown in FIG. 1 includes multiple signal transmission lines 11 arranged in a first direction X. The parallel receiver module 1 is, for example, an optical parallel receiver module and includes a ribbon (multicore) optical fiber 10. The ribbon optical fiber 10 is held by a holder 15. The signal transmission lines 11 are optical transmission lines of the ribbon optical fiber 10. The signal transmission lines 11 extend in a second direction Y orthogonal to the first direction X.

The parallel receiver module 1 also includes a photo detector array 20 and a receiving semiconductor chip 30 of a receiving circuit array. The signal transmission line 11 is not limited to an optical transmission line and may be a transmission line of an electrical signal. In such a case, the photo detector array 20 is unnecessary.

The photo detector array 20 includes multiple photo detectors 21 arranged in the first direction X. The photo detectors 21 are, for example, photodiodes.

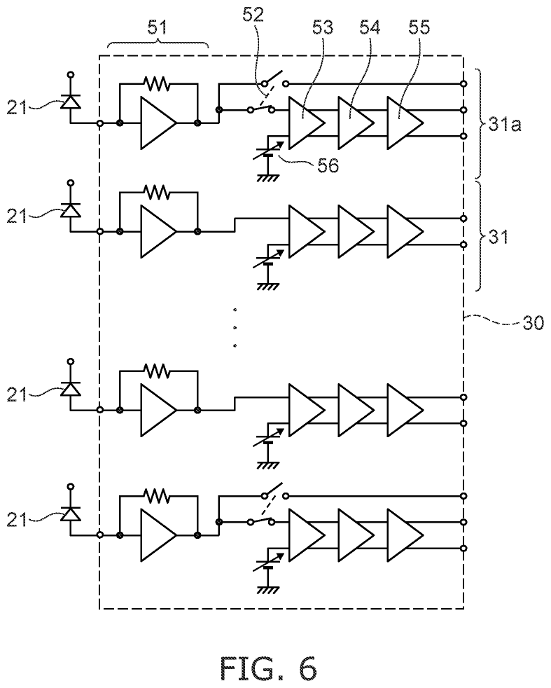

The receiving semiconductor chip 30 is an IC (Integrated Circuit) chip. The receiving semiconductor chip 30 includes multiple receiving channels 31 arranged in the first direction X. Each receiving channel 31 includes a receiving circuit configured to receive a signal from the signal transmission line 11. At least one receiving channel 31a among the multiple receiving channels 31 further includes a monitor circuit monitoring the receiving level of the signal from the signal transmission line 11. In other words, in addition to the same receiving circuit as the other receiving channels 31, the receiving channel 31a further includes a switchable receiving level monitor circuit 52 as shown in FIG. 5. FIG. 6 is an example of a circuit configuration for realizing the functions of FIG. 5. In the example shown in FIG. 1, the receiving channels 31a that include monitor circuits are positioned at the two ends of the multiple receiving channels 31 in the first direction X.

FIGS. 5 and 6 show the photo detector 21, a TIA 51, a receiving level monitor circuit and its switching circuit 52, a data identification circuit 53, a limiting amplifier 54, and an output buffer circuit 55 for matching logic levels of LVDS and CML (Current Mode Logic), etc. A control circuit 56 of FIG. 6 is a control circuit of the data identification threshold and changes the threshold voltage of data identification result information of the data identification circuit 53 and/or the data identification according to the receiving level monitor information described above. The receiving level monitor 52 of FIG. 6 is an alternating connection switch in which one switch is on when the other switch is off, and it is favorable to be able to control the switch state from outside the receiving semiconductor chip 30. The switching control of the receiving level monitor 52 may be controlled by the input of an external logic signal, and by a so-called bonding option in which a portion of the bonding pads of the receiving semiconductor chip 30 is used as a control terminal, and the state is controlled by the connection combination of bonding wires. The difference between the receiving channel 31 and the receiving channel 31a is the existence or absence of the receiving level monitor 52; otherwise, the configurations are exactly the same.

The signal from the signal transmission line 11 that is an optical transmission line is, for example, a high-speed digital optical signal. The photo detector 21 receives the optical signal from the signal transmission line 11, performs photoelectric conversion, and outputs a photocurrent to the receiving channel 31 of the receiving semiconductor chip 30. The receiving circuit of the receiving channel 31 of the receiving semiconductor chip 30 converts the photocurrent input from the photo detector 21 into a digital electrical signal and outputs the digital electrical signal outside the parallel receiver module 1.

The receiving channel 31a includes both the receiving circuit and the monitor circuit and receives the signal from the signal transmission line 11 by switching between the receiving circuit or the monitor circuit. The monitor circuit includes, for example, an integration circuit and outputs the average value of the high-speed signal and sum of DC components from the signal transmission line 11. For the configuration of FIG. 1, the monitor circuit outputs, for example, a voltage value of an average high-speed photocurrent and sum of DC component generated by the photo detector 21 according to the high-speed optical signal from the signal transmission line 11.

For example, the switching between the receiving circuit and the monitor circuit in the receiving channel 31a can be performed by rewriting a program stored in registers embedded in the receiving semiconductor chip 30. The switching also can be performed by switching the bonding wire connection to the receiving semiconductor chip 30. Furthermore, the multiple receiving semiconductor chips 30 can switch between the receiving circuit and the monitor circuit in the receiving channel 31a by, for example, detecting the existence or absence of an optical signal input to detect the connection with the ribbon optical fiber 10.

For example, the photo detector array 20 and the receiving semiconductor chip 30 are mounted to a module package. The signal transmission line 11 (in this case, the optical transmission line 11 of the ribbon optical fiber 10) is optically coupled to the photo detector 21. At this time, the output of the photo detector 21 can be switched to be connected to the monitor circuit in the receiving channel 31a of the receiving semiconductor chip 30. The state in which the output of the photo detector 21 is connected to the monitor circuit in the receiving channel 31a is called the monitor channel and is illustrated by cross hatching in FIG. 1. The state in which the output of the photo detector 21 is connected to the data receiving circuit in the receiving channel 31a is called the transmission channel.

The output when the receiving channel 31a is used as the monitor channel can be output from a terminal other than the output terminal used as the transmission channel, e.g., a terminal connected to a monitor device such as a tester, etc. It can be confirmed whether or not the optical axes of the signal transmission line 11 and the photo detector 21 match based on the output of the monitor channel (the receiving level of the signal from the signal transmission line 11); and optical axis adjustment between the optical fiber 11 and the photo detector 21 is possible.

After the receiving channel 31a is used as the monitor channel and the optical axis adjustment between the optical fiber 11 and the photo detector 21 has ended, the connection destination of the output of the photo detector 21 can be switched to the data receiving circuit so that the receiving channel 31a can be used as a transmission channel similarly to the other receiving channels 31.

It is sufficient for the multiple receiving channels 31 to include at least one receiving channel 31a that includes the monitor circuit. In particular, the accuracy of the optical axis adjustment can be maximized when the receiving channel 31a is used as an optical axis adjustment monitor by using two receiving channels 31a at the two ends of the multiple receiving channels 31 in the first direction X.

The number of parallel receiving channels 31 of the receiving semiconductor chip 30 increases as the number of parallel signal transmission lines 11 increases. Increasing the number of parallel receiving channels 31 inside one receiving semiconductor chip 30 causes higher costs due to lower yield, etc. It is therefore favorable to limit the number of parallel receiving channels 31 inside one receiving semiconductor chip 30 to some number.

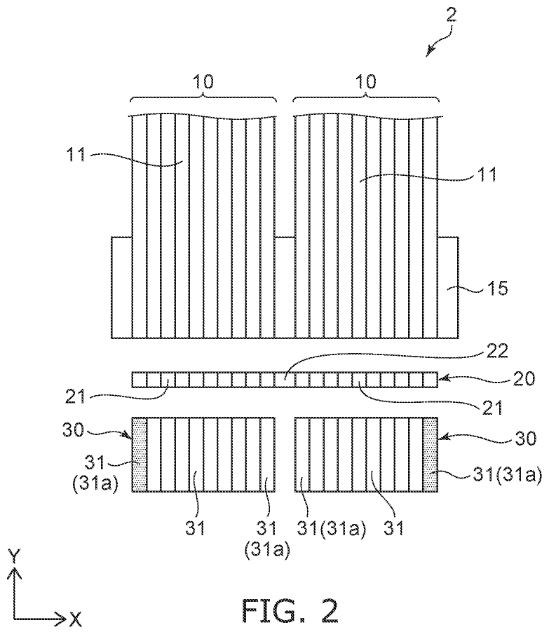

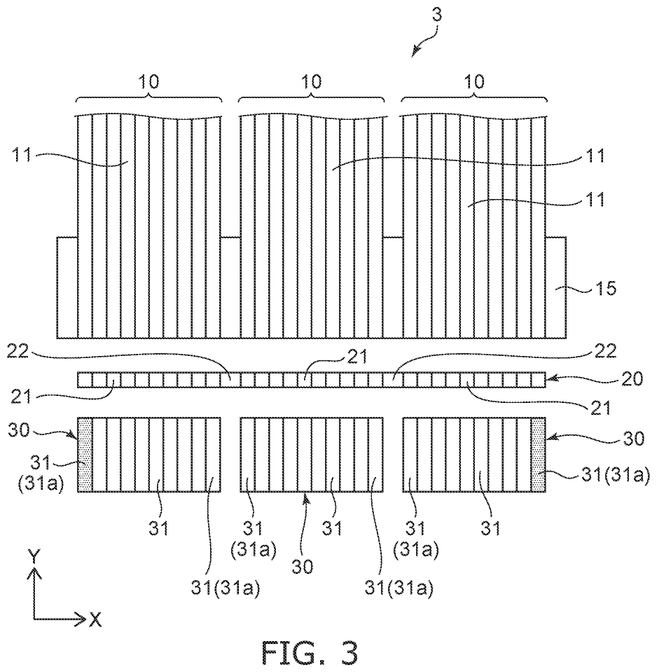

Therefore, as the number of parallel signal transmission lines 11 increases, the number of the receiving semiconductor chips 30 can be increased as shown in FIGS. 2 and 3. The number of parallel photo detectors 21 of the photo detector array increases as the number of parallel signal transmission lines 11 increases. It is favorable to form the photo detector array 20 in one chip to collectively perform optical axis adjustment of the photo detector array 20 and two ribbon optical fibers 10. For example, it is necessary to provide a gap corresponding to a coating resin that is between the ribbon optical fibers 10 adjacent to each other in the first direction X. Therefore, the optical axes of the photo detector array 20 can be matched for all of the two ribbon fibers by setting the gap between the ribbon optical fibers to be an integer multiple of the optical fiber pitch of the ribbon fiber and by arranging the photo detectors at the optical fiber pitch of the ribbon fiber and at the positions corresponding to the gap between the ribbon optical fibers 10. Thereby, many arrays of photo detectors can be formed at a uniform pitch; and by cutting out the photo detector array 20 so that photo detectors that have manufacturing defects correspond to the gap positions described above, the remediable photo detectors can be increased, that is, the yield of the photo detector array 20 can be increased. The photo detector array 20 is made of one chip continuous in the first direction X without being divided between the multiple receiving semiconductor chips 30. A dummy element 22 that does not function as a photo detector may be formed at the positions corresponding to the gaps between the ribbon optical fibers 10. In such a case, the gap between the ribbon optical fibers 10 can be set to any pitch.

If only one receiving semiconductor chip 30 is used in the configuration of FIGS. 2 and 3, unutilized regions that do not function as channels are formed at the positions of the receiving semiconductor chips 30 corresponding to the dummy elements 22 of the photo detector array 20. As the number of parallel signal transmission lines 11 increases, the multiple receiving semiconductor chips 30 can be spaced in the first direction X so that the regions between the receiving semiconductor chips 30 are at positions corresponding to the dummy elements 22, thereby avoiding the formation of unutilized regions in the receiving semiconductor chips 30. In other words, a cost increase of the semiconductor IC (the receiving semiconductor chip 30) that has an extremely large cost per unit area can be suppressed.

A parallel receiver module 2 shown in FIG. 2 includes two receiving semiconductor chips 30 arranged in the first direction X. A parallel receiver module 3 shown in FIG. 3 includes three receiving semiconductor chips 30 arranged in the first direction X. Four or more receiving semiconductor chips 30 may be arranged in the first direction X according to the number of parallel signal transmission lines 11.

The multiple receiving semiconductor chips 30 are the same receiving semiconductor chip. For example, each receiving semiconductor chip 30 includes the receiving channels 31a that include the monitor circuits at the two ends in the first direction X.

In the parallel receiver module 2 of FIG. 2, the receiving channels 31a positioned at the two ends in the first direction X among all receiving channels 31 of the two receiving semiconductor chips 30 are switched to the monitor channels (illustrated by cross hatching). In other words, among the multiple receiving channels 31a, only the receiving channels 31a not adjacent to another receiving semiconductor chip 30 in the first direction X are switched to the monitor channels. Among the multiple receiving channels 31a, the receiving channels 31a adjacent to other receiving semiconductor chips 30 in the first direction X are used as transmission channels. In the receiving semiconductor chip 30 at the left side of FIG. 2, the receiving channel 31a at the left end is switched to the monitor channel; and the receiving channel 31a at the right end is set to the transmission channel. In the receiving semiconductor chip 30 at the right side of FIG. 2, the receiving channel 31a at the right end is switched to the monitor channel; and the receiving channel 31a at the left end is set to the transmission channel.

Among all receiving channels 31 of the three receiving semiconductor chips 30 in the parallel receiver module 3 of FIG. 3 as well, the receiving channels 31a that are positioned at the two ends in the first direction X are switched to the monitor channels (illustrated by the cross hatching). In other words, only the receiving channels 31a at the two ends not adjacent to the other receiving semiconductor chips 30 in the first direction X are switched to the monitor channels. In the receiving semiconductor chip 30 at the left side of FIG. 3, the receiving channel 31a at the left end is switched to the monitor channel; and the receiving channel 31a at the right end is set to the transmission channel. In the receiving semiconductor chip 30 at the right side of FIG. 3, the receiving channel 31a at the right end is switched to the monitor channel; and the receiving channel 31a at the left end is set to the transmission channel. All of the receiving channels 31a of the receiving semiconductor chip 30 (in the example of FIG. 3, one receiving semiconductor chip 30 positioned at the center) positioned between the receiving semiconductor chips 30 positioned at the two ends in the first direction X are used as transmission channels. Among three or more receiving semiconductor chips 30 arranged in the first direction X, all of the receiving channels 31 of the receiving semiconductor chips 30 positioned between the receiving semiconductor chips 30 positioned at the two ends in the first direction X function as transmission channels that do not monitor the receiving levels of the signals from the signal transmission lines 11.

Thereby, in the parallel receiver module that includes the multiple receiving semiconductor chips 30, it is unnecessary to prepare three types of receiving semiconductor chips, i.e., a receiving semiconductor chip for the left end, a receiving semiconductor chip for the right end, and a receiving semiconductor chip for the middle; and all of the parallel receiver modules of FIGS. 1 to 3 can be configured using one type of receiving semiconductor chip.

According to the embodiment, the receiving channels 31a that are included in the receiving semiconductor chip 30 are set to a monitor channel or a transmission channel according to the arrangement position of the receiving semiconductor chip 30 in the first direction X. Thereby, a lower cost can be realized by including one type of receiving semiconductor chip 30 in the parallel receiver module in which it is necessary to arrange the multiple receiving semiconductor chips 30. Simultaneously, it is possible to ensure monitor channels that make it possible to perform axis alignment between the signal transmission lines 11 and the receiving channels 31 of the receiving semiconductor chips 30.

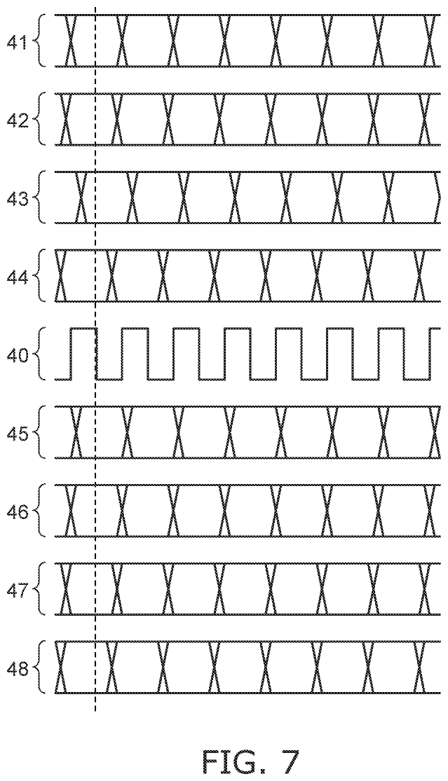

For example, as shown in FIG. 4, the receiving channels 31 use one clock channel and eight data channels as the parallel transmission unit; and the same synchronous clock is used to perform the data discrimination of all data channels inside the parallel transmission unit. Therefore, as shown in FIG. 7, the clock distribution timing is easily made uniform between the data channels by providing the clock channel at the center of the channel arrangement inside the parallel transmission unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A parallel receiver module, comprising:
a plurality of signal transmission lines arranged in a first direction; and
a receiving semiconductor chip including a plurality of receiving channels arranged in the first direction,
the plurality of receiving channels including receiving circuits configured to receive signals from the signal transmission lines,
at least one receiving channel among the plurality of receiving channels further including a monitor circuit monitoring a receiving level of the signal from the signal transmission line,
the at least one receiving channel being connectable with the signal transmission line by switching between the receiving circuit and the monitor circuit.

2. The module according to claim 1, wherein
the signal transmission lines are optical transmission lines of optical fibers, and
the module further comprises a photo detector array receiving optical signals from the optical transmission lines and outputting electrical signals to the receiving channels of the receiving semiconductor chip.

3. The module according to claim 1, wherein
receiving channels among the plurality of receiving channels positioned at two ends in the first direction of the plurality of receiving channels include the monitor circuits.

4. The module according to claim 1, wherein
a plurality of the receiving semiconductor chips is arranged in the first direction.

5. The module according to claim 4, wherein
receiving channels positioned at two ends in the first direction among all of the receiving channels included in the plurality of receiving semiconductor chips include the monitor circuits.

6. The module according to claim 4, wherein
the signal transmission lines are optical transmission lines of optical fibers,
the module further comprises a photo detector array receiving optical signals from the optical transmission lines and outputting electrical signals to the receiving channels of the receiving semiconductor chip, and
the photo detector array is not divided between the plurality of receiving semiconductor chips and is made of one chip continuous in the first direction.

7. The module according to claim 4, wherein
the plurality of receiving semiconductor chips includes three or more receiving semiconductor chips arranged in the first direction, and
among the three or more receiving semiconductor chips, all of the receiving channels of the receiving semiconductor chips positioned between the receiving semiconductor chips positioned at two ends in the first direction of the three or more receiving semiconductor chips function as transmission channels not monitoring the receiving levels of the signals from the signal transmission lines.

8. The module according to claim 1, wherein
the signals from the signal transmission lines are high-speed digital signals, and
the monitor circuit outputs a direct current component or an average value of the high-speed digital signals.
